(19) United States
(12) Patent Application Publication
(10) Pub. No.: US 2007/0162585 A1
(43) Pub. Date: Jul. 12, 2007

(54) Cyber farm system and managing method thereof

(75) Inventor: Chul Yong Jeon, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/642,465

(22) Filed: Dec. 20, 2006

(30) Foreign Application Priority Data
Jan. 6, 2006 (KR) 2006-0001775

(51) Int. Cl. G06F 15/173

(52) U.S. Cl. 709/223

(57) ABSTRACT

A cyber farm system and a managing method thereof that can decorate an individual cyber farm by transmitting items related to the cyber farm to an electronic frame installed in a home using a mobile terminal. The method of managing a cyber farm using an electronic frame in a home network includes receiving a cyber farm item for the cyber farm; receiving a cyber farm program for managing the cyber farm item; managing the cyber farm by performing an operation or a role of the cyber farm item that is set according to the cyber farm program; and managing the cyber farm by providing a new cyber farm item downloaded to a mobile terminal to the electronic frame according to a user's request. Therefore, a user can feel fresh pleasure by making an environment for cyber animals similar to an actual environment.

### PRIORITY

This application claims priority to an application filed in the Korean Intellectual Property Office on 6 Jan. 2006 and assigned Serial No. 2006-0001775, the contents of which are incorporated herein by reference.

### BACKGROUND OF THE INVENTION

1. Field of the Invention

The present invention generally relates to a cyber farm system, and more particularly, to a cyber farm system and a managing method thereof that can decorate an individual cyber farm by transmitting items related to the cyber farm to an electronic frame provided in a home using a mobile terminal.

2. Description of the Related Art

In general, in a situation where almost all appliances in a home including a home network follow a trend of digital convergence, development of a new item that can provide a profit creation opportunity to a service provider and give fresh pleasure and interest to a user is desired. In particular, mobile terminals are widely used and demands for digital convergence using mobile terminals are increasing. Because mobile terminals have recently been provided with a camera, it is possible to photograph with mobile terminals. Photographed images can be transmitted to or received from other persons and be displayed. Further, wired or wireless Internet is used to transmit or receive the photographed image and a Liquid Crystal Display (LCD) TV or a computer monitor is used to display the image. Conventionally, images obtained with several methods were displayed to check the images. However, recently, an electronic frame for always displaying a good scene or scenery has been provided in a home, a company, or a public place to provide a comfortable atmosphere like a natural environment. See, for example, Korean Patent Application No. 1999-02236, “Digital frame for displaying digital image and display method thereof” and Korean Patent Application No. 1998-042483, “Electronic album and electronic frame”.

However, a conventional electronic frame provides simple contents, has only a feature of displaying an image with a large screen, and does not provide various functions, thereby giving a tedious feeling. Accordingly, a conventional electronic frame does not give enough pleasure to a user. Recently, as a hobby, many people have installed a fish tank indoors and bred ornamental fish, provided a pet house and bred small animals, or provided a soil environment for insects indoors and bred various insects. In order to breed a user's favorite animals, such as a fish, a pet, and an insect indoors, etc., a suitable environment in which animals can live should be prepared. However, it is not easy to prepare a suitable environment indoors in which animals can live, and particularly, much space is required and hygiene and management problems may occur. Another example is to breed a cyber animal through the Internet or a game device. However, this is merely a game level and cannot satisfy a user's desire to make an environment for animals indoors similar to an actual environment outdoors and to breed animals.

### SUMMARY OF THE INVENTION

The present invention has been made in an effort to solve the above problems, and an object of the present invention is to provide a cyber farm system and a managing method thereof with which a user can feel fresh pleasure by making an environment for cyber animals similar to an actual environment in a place where a home network is available and by simulating breeding a user's favorite real animals in a cyber environment indoors.

Another object of the present invention is to provide a cyber farm system and a managing method thereof by which a user can feel individual pleasure and interest through an electronic frame indoors, and that can provide an opportunity of new profit creation to a service provider of cyber farm items.

Another object of the present invention is to provide a managing method of a cyber farm system that periodically provides a new cyber farm item for managing a cyber farm, and thereby gives an on-the-spot feeling of pleasure through the instantaneous display of the cyber farm item when newly providing an item.

Another object of the present invention is to provide a managing method of a cyber farm system that can transmit cyber items related to the cyber farm to an electronic frame by performing a throwing motion towards the electronic frame with the hand holding a mobile terminal to give a higher sense of reality to the user in managing a cyber farm.

In accordance with an aspect of the present invention, the above and other objects are accomplished by a method of managing a cyber farm using an electronic frame in a home network, the method including receiving a cyber farm item for the cyber farm; receiving a cyber farm program for managing the cyber farm item; managing the cyber farm by performing an operation or a role of the cyber farm item that is set according to the cyber farm program; and managing the cyber farm by providing a new cyber farm item downloaded to a mobile terminal to the electronic frame according to a user's request.

Preferably, the cyber farm item and the cyber farm program are received from a service management server connected to the Internet through a home server connected to the electronic frame.

Alternatively, the cyber farm item and the cyber farm program are received from a service management server through the Internet directly connected to the electronic frame.

Preferably, a new cyber farm item is downloaded from the service management server through a wireless Internet and stored in a mobile terminal, and is transmitted from the mobile terminal to the electronic frame through the home server.

Alternatively, a new cyber farm item is downloaded from the service management server through wireless Internet and stored in a mobile terminal, and is directly transmitted from the mobile terminal to the electronic frame.

Preferably, transmission of the cyber farm item from the mobile terminal is performed through a short range communication channel.

Preferably, the cyber farm item stored in the mobile terminal is transmitted to the electronic frame and is displayed on a screen by performing a throwing motion towards the electronic frame with the hand holding the mobile terminal.

Preferably, transmission of the cyber farm item by performing a throwing motion towards the electronic frame with the hand holding the mobile terminal includes selecting and displaying the cyber farm item stored in the mobile terminal on a screen; operating a motion recognition means in a state where the cyber farm item is displayed; performing a throwing motion towards the electronic frame with the hand holding the mobile terminal in a state of operating the motion recognition means; recognizing the throwing motion; and transmitting the cyber farm item from the mobile terminal to the electronic frame by recognizing the throwing motion and simultaneously setting a short range communication channel between the electronic frame and the mobile terminal.

In accordance with another aspect of the present invention, the above and other objects are accomplished by a cyber farm system including an electronic frame for displaying cyber farm items such as environment elements and various cyber animals constituting a cyber farm according to a cyber farm program; a mobile terminal for downloading and storing environment elements and cyber farm items for the cyber farm according to a user's request and providing the cyber farm items to the electronic frame; and a service management server connected to the electronic frame for providing basic environment elements and managing the cyber farm according to the cyber farm program.

In accordance with another aspect of the present invention, the above and other objects are accomplished by a cyber farm system including an electronic frame for a cyber farm, wherein the electronic frame includes a memory for receiving and storing a cyber farm item and a cyber farm program; a controller for controlling to perform an operation and a role of the cyber farm item that is set according to the cyber farm program; a short range communication unit for receiving the cyber farm item from a short range area; and a communication unit for receiving the cyber farm program, a basic environment element and cyber farm items.

In accordance with another aspect of the present invention, the above and other objects are accomplished by a cyber farm system including a mobile terminal for a cyber farm, wherein the mobile terminal includes an input unit for selecting each function related to management of the cyber farm; a reception unit for receiving and storing a cyber farm item through a wireless Internet according to the input from the input unit; a short range communication unit for transmitting the cyber farm item to an electronic frame through a short range communication channel; a recognition unit for recognizing a throwing motion towards the electronic frame with the hand holding the mobile terminal for transmission of the cyber farm item to the electronic frame; and a controller for controlling to transmit the cyber farm item to the electronic frame through the short range communication unit upon recognition of the throwing motion.

### BRIEF DESCRIPTION OF THE DRAWINGS

The above and other objects, features and advantages of the present invention will be more apparent from the following detailed description in conjunction with the accompanying drawings, in which:

FIG. 1 is a diagram illustrating a configuration of a cyber farm system including a home network and wired and wireless Internet networks according to the present invention;

FIG. 2 is a block diagram illustrating a configuration of a mobile terminal according to the present invention;

FIG. 3 is a flowchart illustrating a method of implementing a cyber farm according to the present invention;

FIG. 4 is a flowchart illustrating a process of purchasing a new cyber farm item in the method of FIG. 3;

FIG. 5 is a message flow diagram illustrating a process of management of the cyber farm in the method of FIG. 3;

FIG. 6 is a flowchart illustrating another method of implementing a cyber farm according to the present invention;

FIG. 7 is a flowchart illustrating a process of purchasing a new cyber farm item in the method of FIG. 6;

FIG. 8 is a display representation of an implementation of a cyber farm displayed in an electronic frame according to the present invention;

FIG. 9 is a diagram illustrating another configuration of a cyber farm system including a home network and wired and wireless Internet networks according to the present invention; and

FIG. 10 is a message flow diagram illustrating a process of management of the cyber farm in the method of FIG. 6.

### DETAILED DESCRIPTION OF PREFERRED EMBODIMENTS

Preferred embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

While the present invention may be embodied in many different forms, specific embodiments of the present invention are shown in the drawings and are described herein, with the understanding that the present disclosure is to be considered as an exemplification of the principles of the invention and is not intended to limit the invention to the specific embodiments illustrated.

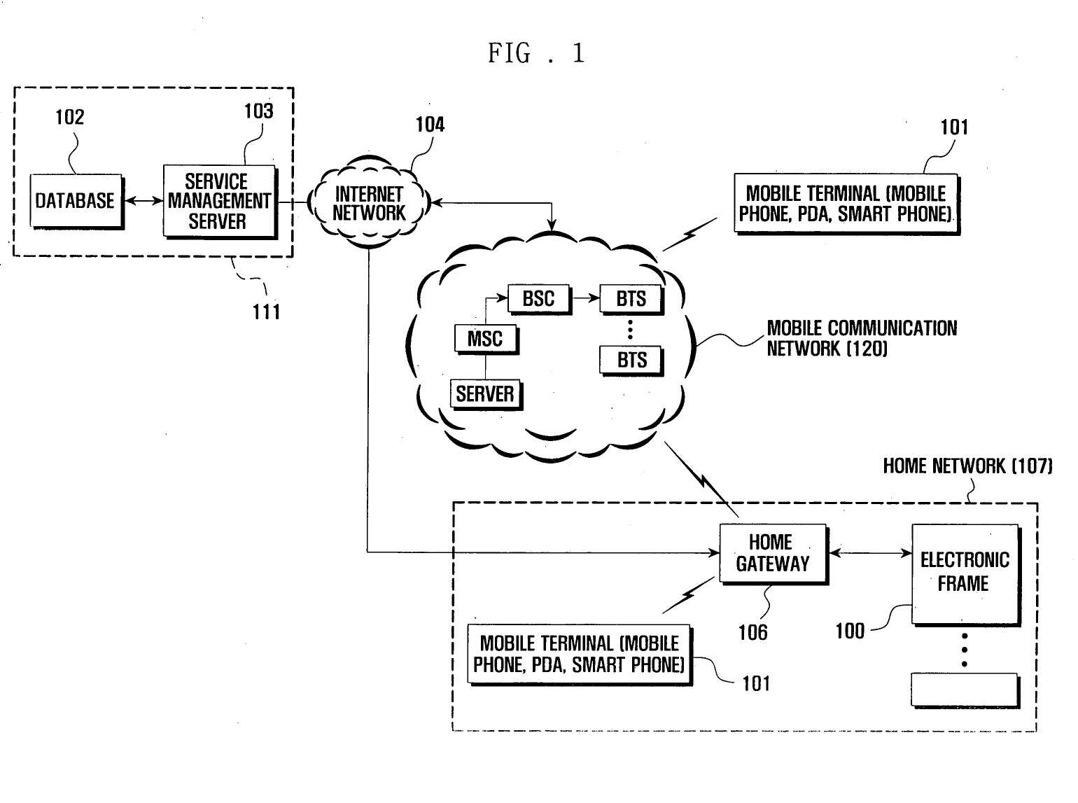

As shown in FIG. 1, a cyber farm system according to the present invention includes a service provider 111, a home network 107, and a mobile terminal 101.

The home network 107 includes a home gateway 106 and a plurality of electronic appliances connected to the home gateway 106. A cyber farm is embodied using an electronic frame 100 among the plurality of electronic appliances.

Although not shown in FIG. 1, the home gateway 106 includes a home server and a database, and the home server is connected to the electronic frame 100, a power line communication (PLC), and a universal serial bus (USB) by a wired link.

The mobile terminal 101, which may be a mobile phone, Personal Digital Assistant (PDA), smart phone, etc., controls electronic appliances through the home gateway 106, controls the home network 107 when indoors using a short range communication channel, such as Bluetooth®, Zigbee, etc., and controls the home network 107 when outdoors using a mobile communication network 120.

The mobile terminal 101 communicates with the electronic frame 100 through the home gateway 106 when indoors, and communicates with the electronic frame 100 through the mobile communication network 120 and the home gateway 106 when outdoors, thereby performing a function as a digital convergence appliance. The mobile terminal 101 connects to the Internet network 104 through the mobile communication network 120 to purchase environment elements for cyber animals and new items for the cyber farm, such as various cyber animals, and to transmit the elements and items, through the home gateway 106 or directly, to the electronic frame 100. The electronic frame 100 connected to the home gateway 106 displays an environment for cyber animals in a cyber farm and several cyber animals located at the environment, and receives a new item through the mobile terminal 101 and immediately displays the item. The display is instantaneously performed and thus provides a sense of reality to the user.

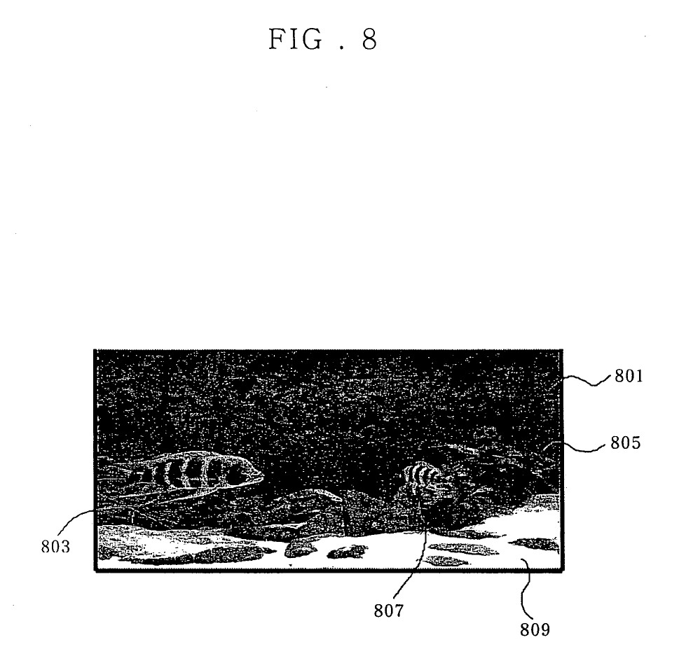

As shown in FIG. 8, for example, in a cyber fish tank, a basic environment element for a cyber farm, such as a water plant, a rock, etc., basic items for a cyber farm, such as a representative fish, and a cyber farm program for managing them are provided.

The service provider 111 includes a database 102 and a service management server 103. The service provider 111 provides various contents for a cyber farm, stores the contents in the database 102, concludes a membership contract with a user through the service management server 103, and sells the item if item purchase is requested. The service provider 111 provides a basic cyber farm item to the electronic frame 100 of a contractor free of charge within a predetermined duration or transmits advertisement information about a newly developed cyber farm item to guide a user's purchase.

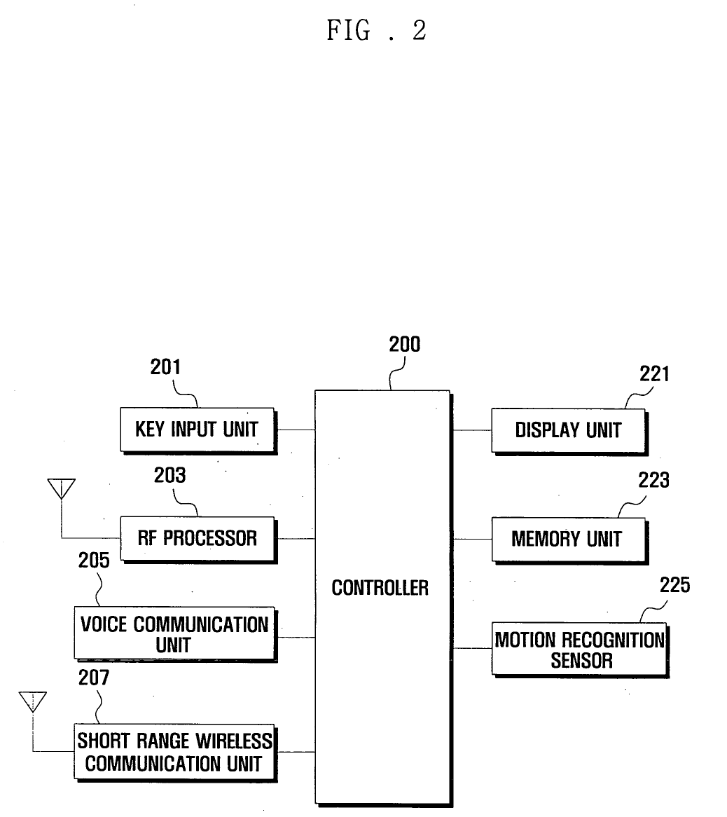

FIG. 2 shows a mobile terminal 101 according to the present invention. The mobile terminal 101 controls a home network 107 through a short range wireless communication unit 207 and controls a cyber farm displayed in the electronic frame by transmitting cyber farm item data to the electronic frame 100. The cyber farm item is received through the radio frequency (RF) processor 203 by connecting to the service provider 111, and stored in a memory unit 223.

A new cyber farm item is transmitted to the electronic frame 100 by the user performing a throwing motion towards the electronic frame 100 with the hand holding the mobile terminal 101, and the motion is sensed by a motion recognition sensor 225. When the user performs a throwing motion towards the electronic frame 100 with the hand holding the mobile terminal 101 while pressing a motion recognition button of the key input unit 201 of the mobile terminal 101, the controller 200 determines, if the motion recognition sensor 225 senses the motion, that an operation for transmitting a new cyber farm item to the electronic frame 100 is performed. Accordingly, the controller 200 of the mobile terminal 101 controls to transmit the new cyber farm item stored in the memory 223 to the electronic frame 100. The new cyber farm item is displayed in a display unit 221 for a user's check before transmitting to the electronic frame 100 by the control of the controller 200.

The short range wireless communication unit 207 transmits the item to the electronic frame 100 through short range communication channel, directly or through the home gateway 106, by the control of the controller 200.

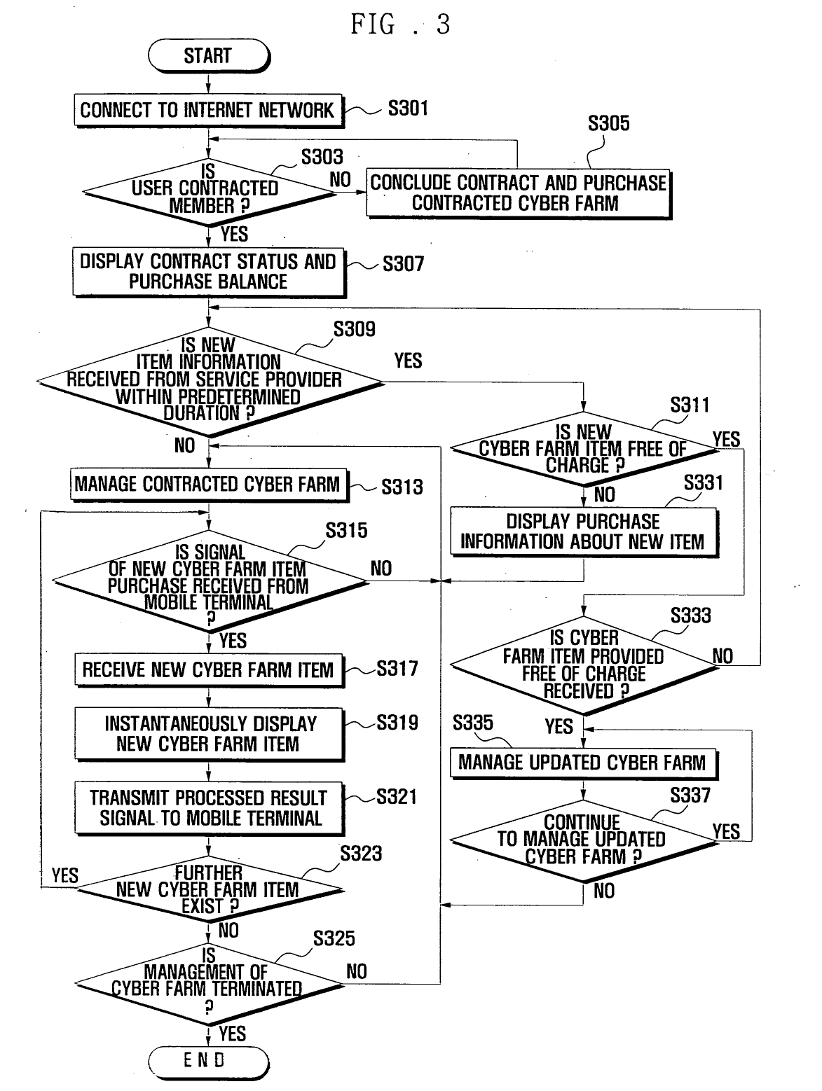

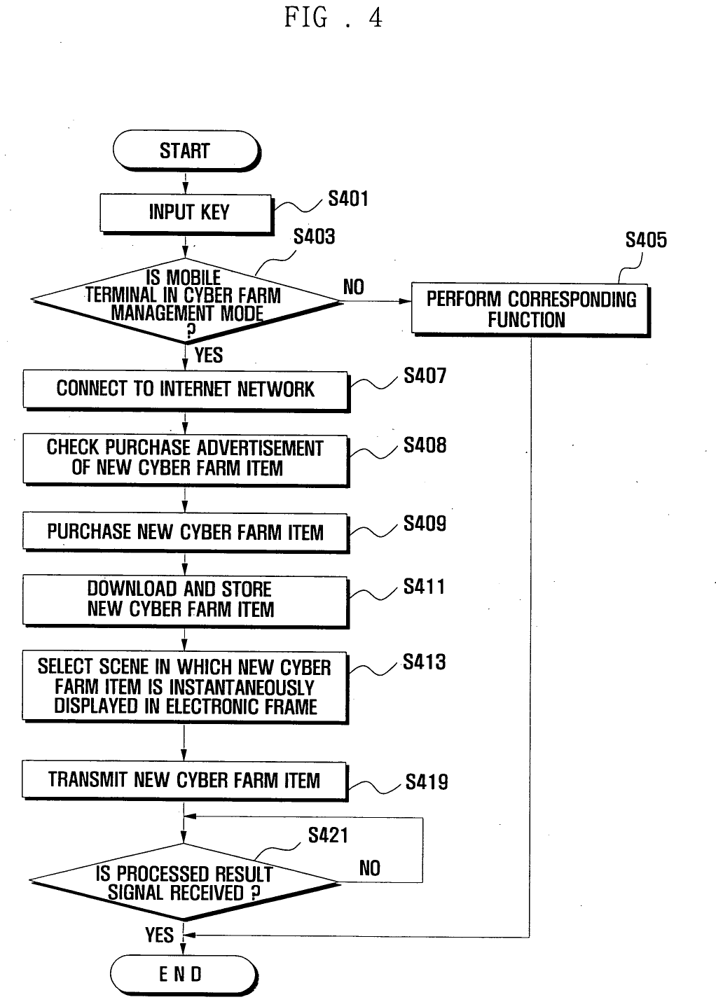

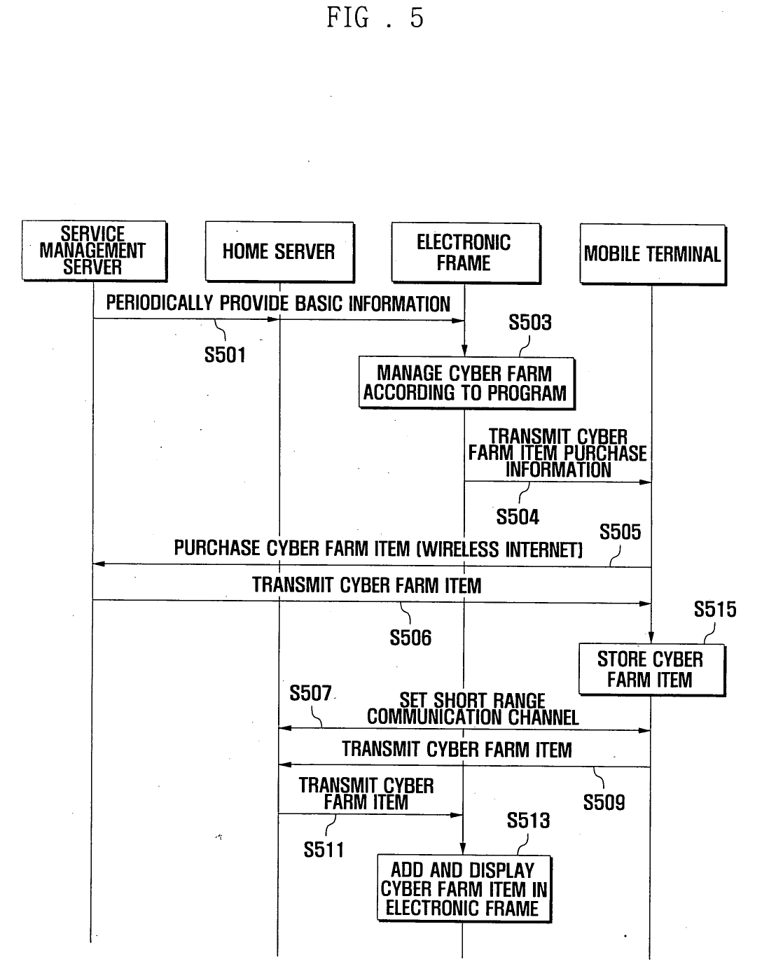

FIG. 3 shows a method of implementing a cyber farm according to the present invention, in an environment in which the Internet network 104 is connected to the home server of a home gateway 106 in the home network 107 having the electronic frame 100. FIG. 4 shows a process of purchasing a new cyber farm item in the method of FIG. 3. A process of management of the cyber farm according to the method of FIG. 3 is shown in the message flow diagram of FIG. 5.

As shown in FIG. 3, the electronic frame 100 is one of a plurality of electronic appliances provided in a wall, the home server of the home gateway 106 is connected to the Internet network 104, and the electronic frame 100 is connected to the home gateway 106, thereby embodying a cyber farm. The electronic frame 100 periodically receives basic information for a cyber farm from the service management server 103 of the service provider 111 through the Internet network 104 and manages a cyber farm according to a management program.

If a user connects to the Internet network 104 in step S301, the service provider 111 checks whether the user is a contracted member in step S303. If the user is not a contracted member, the user concludes a contract for a cyber farm with the service provider 111 and purchases the contracted cyber farm in step S305. If the user is a member, through having concluded a contract, a contract status and a purchase balance are displayed in a monitor of the home server or in the electronic frame 100 in step S307. The user can receive a cyber farm item to decorate a cyber farm in the electronic frame 100 and periodically receive updated items from the service management server 103 of the service provider 111. However, in order to manage an unusual and user-specific cyber farm, a special item is purchased, and this process is described later in relation to FIG. 4.

The home server of the home gateway 106 checks whether new item information from the service management server 103 of the service provider 111 is received within a predetermined duration in step S309. If no new item information from the service management server 103 is received, a basic cyber farm having no special item is executed according to a management program, and is displayed in the electronic frame 100 in step S313.

If new item information is received at step S309, the home server checks whether a new item for the cyber farm is provided free of charge within a predetermined duration from the service management server 103 of the service provider 111 to the user in step S311. If a cyber farm item is provided free of charge, and the item is received by the user in step S333, the existing cyber farm that has been contracted and managed is updated with the cyber farm item received free of charge in step S335. The home server checks whether to continue management of the updated free cyber farm in step S337. According to a user's selection, the home server can return to managing the previously contracted basic cyber farm in step S313 or can continue to manage the updated cyber farm in step S335.

If a new item is not provided free of charge at step S311, the new item information is displayed as a purchase advertisement in step S331 and thus guides a purchase of the new item. When the purchase advertisement ends, the original basic cyber farm is managed and displayed in the electric frame 100 in step S313. If the user feels that a new cyber farm item introduced for purchase at step S331 is required to decorate a cyber farm, the user buys the item in the mobile terminal 101 as in FIG. 4.

Referring to FIG. 4, which shows a process of purchasing a new cyber farm item in the method of FIG. 3, if a key is input through the key input unit 201 of the mobile terminal 101 in step S401, the controller 200 checks whether the mobile terminal 101 is in a cyber farm management mode in step S403. If the mobile terminal 101 is not in a cyber farm management mode, the mobile terminal 101 performs a corresponding function in step S405. If the mobile terminal 101 is in a cyber farm management mode, the mobile terminal 101 is connected to the Internet network 104 through the mobile communication network 120 in step S407. The mobile terminal 101 connects to the service management server 103 of the service provider 111 through the Internet network 104, and the user becomes a member and concludes a contract for using a cyber farm.

When the contract has been concluded with the service provider 111, a purchase advertisement for the cyber farm newly provided from the service management server 103 of the service provider 111 is checked through the display unit 221 of the mobile terminal 101 in step S408, and a purchase item is selected and purchased through the key input unit 201 (S409).

The selection for a purchase item is transferred to the service management server 103 by the control of the controller 200, and after checking receipt of correct payment, the service management server 103 downloads the purchased item from the database 102 and transmits it to the mobile terminal 101, where the item is received through the RF processor 203 and stored in the memory unit 223 by the control of the controller 200 in step S411 (shown in FIG. 5 as step S515). After setting a short range communication channel between the home server and the mobile terminal 101 (step S507 in FIG. 5), the new cyber farm item stored in the memory unit 223 is transmitted via the home gateway 106 (step S509 in FIG. 5) to the electronic frame 100 (step S419 in FIG. 4, S511 in FIG. 5), and is instantaneously displayed in the electronic frame 100 in step S413 (step S513 in FIG. 5).

On receipt of the new cyber farm item, the processed result of the electronic frame 100 is transmitted from the home server of the home gateway 106 to the mobile terminal 101. When the controller 200 receives the processed result in step S421, the purchasing process of FIG. 4 finishes.

Returning to FIG. 3, in a state where the basic cyber farm is managed in step S313, the home server of the home gateway 106 checks whether a signal indicating purchase of a new cyber farm item is received from the mobile terminal 101 in step S315. If a new cyber farm item is received, the home server transmits the item to the electronic frame 100 in step S317. The new cyber farm item is instantaneously displayed in the electronic frame 100 as a moving image in the basic cyber farm in step S319, so that, for example, if the electronic frame 100 shows a cyber fish tank, the user feels as if they are putting a real fish in a fish tank, and if the electronic frame 100 shows a cyber deer farm, the user feels as if they are giving food to real deer. The processed result of the electronic frame 100 is transmitted from the home server of the home gateway 106 to the mobile terminal 101 in step S321. The electronic frame 100 checks whether a new cyber farm item further exists in the mobile terminal 101 in step S323. If a new cyber farm item does not exist, the user determines whether to terminate management of the cyber farm in step S325, and if the user determines to terminate the cyber farm, the process ends. If the user determines not to terminate management of the cyber farm, the process returns to step S313 and the cyber farm is managed. If a further cyber farm new item exists at step S323, the process returns to step S315 and checks whether a signal indicating purchase of a new cyber farm item is received from the mobile terminal 101.

FIG. 8 is a display representation of an implementation of a cyber farm (here, a fish tank) displayed in an electronic frame according to the present invention. In a state where the basic cyber farm includes a fish tank 801 containing water plants 805 and base sand 809, new items, such as fishes 803 and 807, may be purchased and added so the user feels as if they are putting fish into the fish tank 801.

In the cyber farm within the electronic frame 100 connected to the service management server 103 of the service provider 111, a new cyber farm item received by the user through the mobile terminal 101 can be checked, and an operation or a role of the item that is set according to a cyber farm program can be performed.

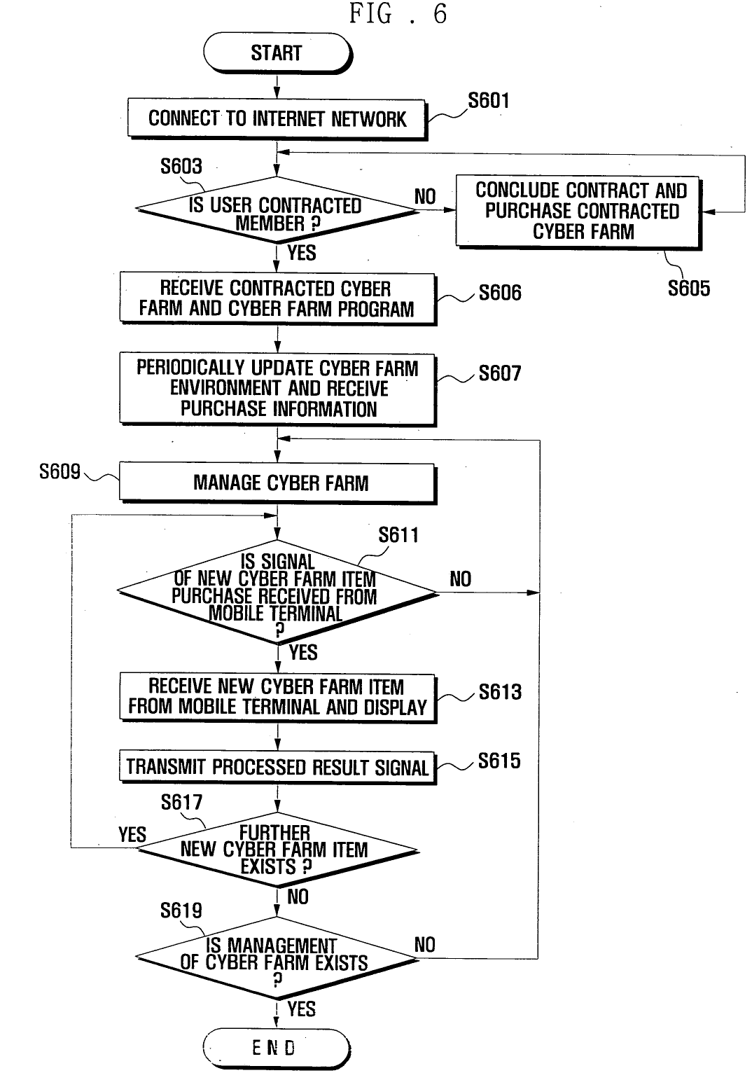

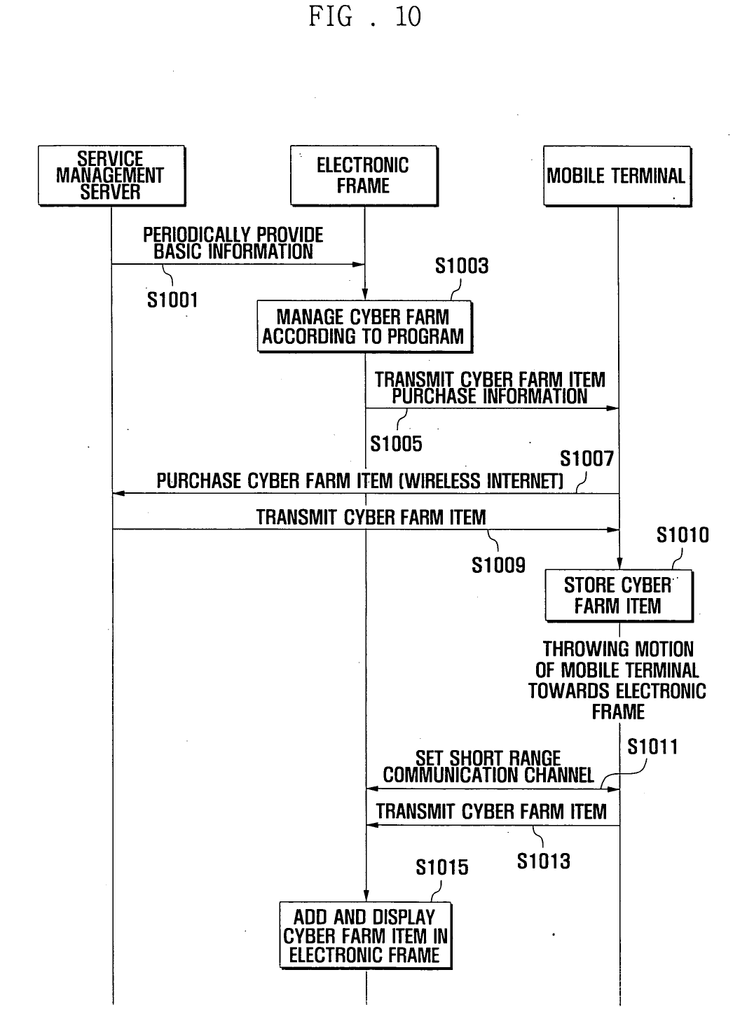

FIG. 6 shows another method of implementing a cyber farm according to the present invention, in an environment in which the electronic frame 100 is connected directly to the Internet network 104. FIG. 10 shows a process of management of the cyber farm in the method of FIG. 6.

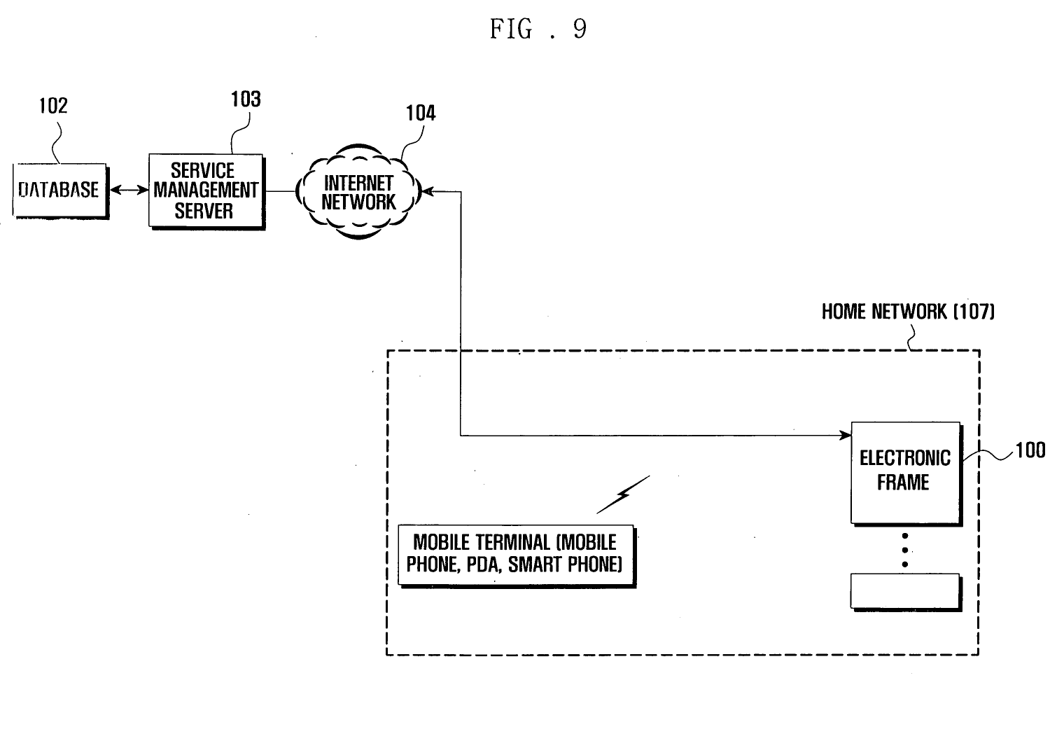

In FIG. 6, the electronic frame 100 installed in a wall is not connected to the home server of the home gateway 106, as shown in FIG. 9, which shows another configuration of a cyber farm system including a home network and wired and wireless Internet networks according to the present invention.

The electronic frame 100 can be directly connected to the service management server 103 through the Internet network 104 in step S601. The service provider 111 checks whether the user is a contracted member in step S603. If the user is not a contracted member, the user concludes a contract for a cyber farm with the service provider 111 and purchases the contracted cyber farm in step S605. The electronic frame 100 of the contracted member receives, for example, environment elements of a basic cyber farm having no special items, items for the cyber farm, such as various cyber animals, and a cyber farm program for managing them in step S606 (shown in FIG. 10 as S1001), and the basic cyber farm is managed according to the program (step S1003 in FIG. 10).

In the electronic frame 100, environment elements of the cyber farm are periodically updated through the service management server 103, purchase advertisements of a new cyber farm item are received by the mobile terminal 101 or various information related to cyber farm management is received by the terminal 101 in step S607 (step S1005 in FIG. 10), and a cyber farm program is managed by updating the cyber farm basically provided with purchased environment elements, items for a cyber farm, such as various cyber animals, and cyber farm items provided free of charge in step S609.

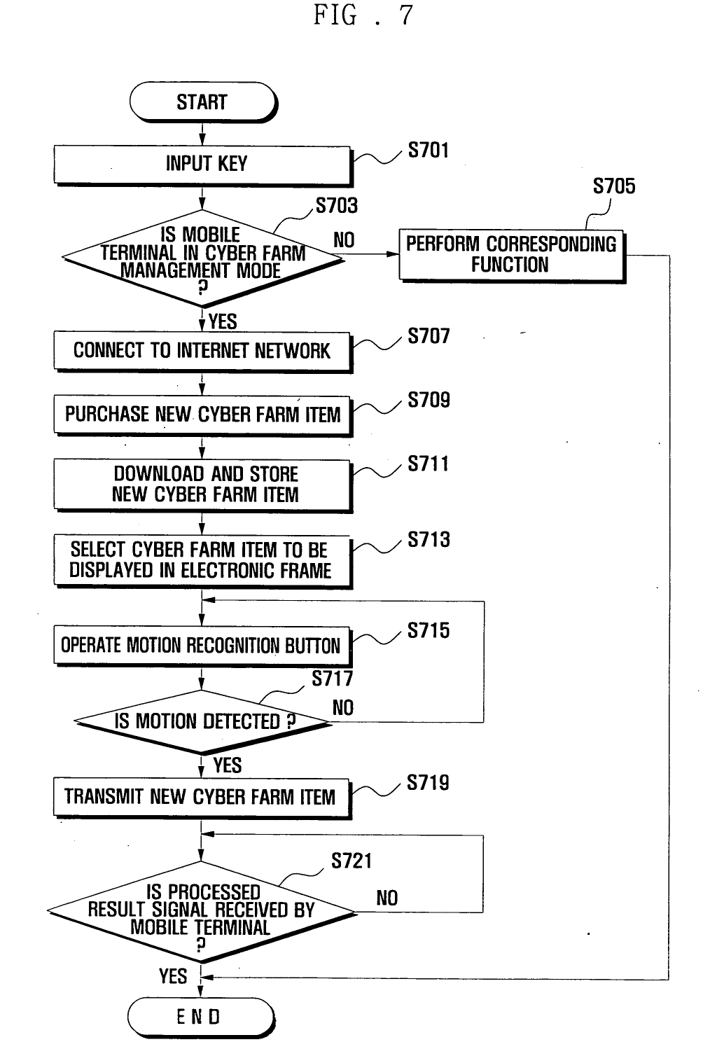

A purchase advertisement of a new cyber farm item is periodically provided through the service management server 103 and the user purchases the new cyber farm item through the mobile terminal 101 as in FIG. 7.

FIG. 7 shows a process of purchasing a new cyber farm item in the method of FIG. 6, by performing a throwing motion towards the electronic frame 100 with the hand holding the mobile terminal 101, thereby giving a sense of reality in managing the farm.

Referring to FIG. 7, if a key is input through the key input unit 201 of the mobile terminal 101 in step S701, the controller 200 checks whether the mobile terminal 101 is in a cyber farm management mode in step S703. If the mobile terminal 101 is in a cyber farm management mode, the mobile terminal 101 is connected to the Internet network 104 through a mobile communication network in step S707. The mobile terminal 101 connects to the service management server 103 of the service provider 111 through the Internet network 104, and the user becomes a member and concludes a contract for using a cyber farm.

When the contract has been concluded with the service provider 111, the mobile terminal 101 is connected to the service management server 103 of the service provider 111, and the user checks a purchase advertisement for a new cyber item of the cyber farm provided from the service management server 103 of the service provider 111 through the display unit 221 (step S1005 in FIG. 10), and purchases the new item in step S709 (step S1007 in FIG. 10). If there is no problem in a transaction between the user and the service management server 103 of the service provider 111, the service management server 103 transmits a new cyber farm item stored in the data base 102 to the mobile terminal 101 (step S1009 in FIG. 10) and the mobile terminal 101 receives a cyber farm item through the RF processor 203 and stores the item in the memory unit 223 by the control of the controller 200 in step S711 (step S1010 in FIG. 10).

If an item to be displayed in the electronic frame 100 is selected in step S713, in order to give a higher sense of reality in managing a cyber farm to the user, a throwing motion towards the electronic frame 100 with the hand holding the mobile terminal 101 while pressing a motion recognition button in the key input unit 201 is performed in step S715. The controller 200 checks whether the motion is detected by the motion recognition sensor 225 in step S717. If the motion is detected, a newly purchased cyber farm item selected through the short range wireless communication unit 207 of the mobile terminal 101 is transmitted to the electronic frame 100 in step S719 (step S1011, S1013 in FIG. 10).

On receipt of the new cyber farm item, the processed result of the electronic frame 100 is transmitted to the mobile terminal 101. When the controller 200 receives the processed result in step S721, the purchasing process of FIG. 7 finishes.

Returning to FIG. 6, the electronic frame 100 checks whether a signal indicating purchase of a new cyber farm item is received through the mobile terminal 101 in step S611. If a signal is received, since the short range wireless communication unit exists even in the electronic frame 100, the electronic frame 100 receives the signal directly, the new item transmitted from the mobile terminal 101 is added to the basic cyber farm managed at step S609, and the electronic frame 100 performs instantaneous display to give a sense of reality in step S613 (step S1015 in FIG. 10). The user can experience the electronic frame 100 as an environment of animals similar to a real environment. For example, if the environment of cyber animals is a cyber fish tank, the user can feel as if they are directly putting a real fish into a fish tank, or if the environment of cyber animals is a cyber deer farm, the user can feel as if they are directly giving food to real deer. That is, the user can feel as if they are actually raising a real animal.

Next, the electronic frame 100 transmits a processed result signal to the mobile terminal 101 in step S615. The electronic frame 100 checks whether a new cyber farm item further exists in the mobile terminal 101 in step S617. If a new cyber farm item does not exist, the user determines whether to terminate management of the cyber farm in step S619, and if the user determines to terminate the cyber farm, the process ends. If the user determines not to terminate management of the cyber farm, the process returns to step S609 and the cyber farm is managed. If a further new cyber farm item exists at step S617, the process returns to step S611 and checks whether a signal indicating purchase of a new cyber farm item is received from the mobile terminal 101.

As a method of giving a higher sense of reality in managing a cyber farm as described above, an item is transmitted by performing a throwing motion towards the electronic frame 100 with the hand holding the mobile terminal 101. That is, if the mobile terminal 101 transmits an inquiry to peripheral devices through a short range communication channel, the peripheral devices respond to the inquiry. In another example of the present invention, a throwing motion towards the electronic frame 100 with the hand holding the mobile terminal 101 can be recognized using a directional antenna technology and a direction/operation/acceleration recognition technology. If a throwing motion towards the electronic frame 100 with the hand holding the mobile terminal 101 is performed, an inquiry signal is sent only to the electronic frame 100. When a short range communication channel is set by a quick response of the electronic frame 100, an item of the mobile terminal 101 is directly transmitted to the electronic frame 100. That is, the mobile terminal 101 recognizes a direction and an angle if a throwing motion is performed, transmits a signal corresponding to the direction and angle through a directional antenna, and performs the connection and data transmission.

As described above, according to the present invention, a user can feel as if they are, for example, putting a real fish in a fish tank if an electronic frame shows a cyber fish tank, or giving food to real deer if an electronic frame shows a cyber deer farm, through a display in which a new item instantaneously appears in a cyber farm displayed in an electronic frame. Further, the user can feel a sense of reality as described above by performing a throwing motion towards the electronic frame with the hand holding the mobile terminal, so the user can feel new pleasure and interest indoors and a service provider can have an opportunity of new profit creation.

Although preferred embodiments of the present invention have been described in detail hereinabove, it should be clearly understood that many variations and modifications of the basic inventive concepts herein taught that may appear to those skilled in the present art will still fall within the spirit and scope of the present invention, as defined in the appended claims.

What is claimed is:

1. A method of managing a cyber farm using an electronic frame in a home network, the method comprising:
receiving a cyber farm item for the cyber farm;
receiving a cyber farm program for managing the cyber farm item;
managing the cyber farm by performing an operation or a role of the cyber farm item that is set according to the cyber farm program; and
managing the cyber farm by providing a new cyber farm item downloaded to a mobile terminal to the electronic frame according to a user's request.

2. The method of claim 1, wherein the cyber farm item and the cyber farm program are received from a service management server connected to the Internet through a home server connected to the electronic frame.

3. The method of claim 1, wherein the cyber farm item and the cyber farm program are received from a service management server through the Internet directly connected to the electronic frame.

4. The method of claim 2, wherein the service management server updates a cyber farm environment by providing a cyber farm item to the electronic frame free of charge within a predetermined duration and advertises or introduces a new cyber farm item for decorating the cyber farm to a user.

5. The method of claim 2, wherein a new cyber farm item is downloaded from the service management server through a wireless Internet and stored in a mobile terminal, and is transmitted from the mobile terminal to the electronic frame through the home server.

6. The method of claim 3, wherein a new cyber farm item is downloaded from the service management server through a wireless Internet and stored in a mobile terminal, and is directly transmitted from the mobile terminal to the electronic frame.

7. The method of claim 5, wherein transmission of the cyber farm item from the mobile terminal is performed through a short range communication channel.

8. The method of claim 6, wherein the cyber farm item stored in the mobile terminal is transmitted to the electronic frame and is displayed on a screen by performing a throwing motion towards the electronic frame with the hand holding the mobile terminal.

9. The method of claim 8, wherein transmission of the cyber farm item by performing a throwing motion towards the electronic frame with the hand holding the mobile terminal comprises:
selecting and displaying the cyber farm item stored in the mobile terminal on a screen; operating a motion recognition means in a state where the cyber farm item is displayed;
performing a throwing motion towards the electronic frame with the hand holding the mobile terminal in a state of operating the motion recognition means;
recognizing the throwing motion; and
transmitting the cyber farm item from the mobile terminal to the electronic frame by recognizing the throwing motion and simultaneously setting a short range communication channel between the electronic frame and the mobile terminal.

10. The method of claim 8, wherein transmission of the cyber farm item by performing a throwing motion towards the electronic frame with the hand holding the mobile terminal comprises:
transmitting an inquiry signal to the electronic frame through a directional antenna when performing a throwing motion towards the electronic frame with the hand holding the mobile terminal;
setting a short range communication channel when the inquiry signal is received by the electronic frame; and
transmitting immediately a cyber farm item of the mobile terminal to the electronic frame after the setting of the short range communication channel.

11. A cyber farm system comprising:
an electronic frame for displaying cyber farm items constituting a cyber farm according to a cyber farm program;
a mobile terminal for downloading and storing cyber farm items for the cyber farm according to a user's request and providing the cyber farm items to the electronic frame; and
a service management server connected to the electronic frame for providing the cyber farm items and managing the cyber farm according to the cyber farm program.

12. The system of claim 11, wherein the cyber farm items include environment elements and various cyber animals.

13. A cyber farm system comprising an electronic frame for a cyber farm, wherein the electronic frame comprises:
a memory for receiving and storing a cyber farm item and a cyber farm program;
a controller for controlling to perform an operation and a role of the cyber farm item that is set according to the cyber farm program;
a short range communication unit for receiving the cyber farm item from a short range area; and
a communication unit for receiving the cyber farm program, a basic environment element and cyber farm items.

14. A cyber farm system comprising a mobile terminal for a cyber farm, wherein the mobile terminal comprises:
an input unit for selecting each function related to management of the cyber farm;
a reception unit for receiving and storing a cyber farm item through a wireless Internet according to input from the input unit;
a short range communication unit for transmitting the cyber farm item to an electronic frame through a short range communication channel;
a recognition unit for recognizing a throwing motion towards the electronic frame with the hand holding the mobile terminal for transmission of the cyber farm item to the electronic frame; and
a controller for controlling to transmit the cyber farm item to the electronic frame through the short range communication unit upon recognition of the throwing motion.
